(19) United States
(12) Patent Application Publication
(10) Pub. No.: US 2007/0014715 A1
(43) Pub. Date: Jan. 18, 2007

(54) Method and apparatus for the preparation of porous materials and mixed metal oxides

(75) Inventors: Jong-San Chang, Daejeon-city (KR); Sung-Hwa Jhung, Daejeon-city (KR); Young-Kyu Hwang, Daejeon-city (KR); Jin-Soo Hwang, Daejeon-city (KR)

Correspondence Address: THE WEBB LAW FIRM, P.C., 700 KOPPERS BUILDING, 436 SEVENTH AVENUE, PITTSBURGH, PA, 15219, US

(73) Assignee: Korea Research Institute of Chemical Technology, Daejeon-city (KR)

(21) Appl. No.: 11/485,008

(22) Filed: Jul. 12, 2006

(30) Foreign Application Priority Data
Jul. 14, 2005 (KR) 10-2005-0063515

(51) Int. Cl. C01G 23/00

(52) U.S. Cl. 423/598; 423/593.1; 423/700; 423/305

(57) ABSTRACT

Disclosed herein is a method for the preparation of porous materials, which can be used not only for a catalyst, an adsorbent, a catalytic support, ion exchange and gas storage, but also for adsorbent of guest molecules due to nanometer spaces (nanospaces), and of mixed metal oxides which are used as functional ceramic materials. More particularly, disclosed is a method for the preparation of porous materials and mixed metal oxides, in which microwave energy is used as a heating source, and a tube free of connection portions is used as a reactor, and the pressure within the reactor is controlled by measuring the pressure of gas remaining after the separation of solid and liquid, so that the method has increased operational stability and reproducibility, makes the control of residence time easy, and can achieve an increase in productivity. Also, disclosed is an apparatus for the continuous preparation of porous materials and mixed metal oxides, which can perform the preparation method.

### TECHNICAL FIELD

The invention relates to a method and apparatus for continuously preparing materials, including porous materials and mixed metal oxides. More particularly, the inventive method adopts microwave heating as a heat source for hydrothermal or solvo-thermal synthetic reaction, in place of conventional electric heating, and utilizes a tube having no connection, as a reactor.

Also, the inventive method is characterized in that temperature and pressure sensors are provided at a region which is not irradiated with microwaves, and the reaction is performed while the pressure within the reactor is controlled by measuring the pressure of gas after the separation of solid and liquid. Furthermore, in the present invention, if the residence time in the reactor needs to be increased or productivity is to be increased, reaction is then performed using at least two reactors which are connected to one another in series or in parallel in such a manner that the connection portion between the reactors is positioned at a region which is not irradiated with microwaves, to thereby increase stability. In addition, the present invention relates to an apparatus for continuously preparing said materials, which is used in this preparation method.

### BACKGROUND ART

Porous material refers to a material comprising silicon (Si), aluminum (Al), phosphorus (P), and oxygen (C), and particularly means a compound having pores of less than 50 nm in size (Nature, vol. 417, p. 813 (2002), Pure and Applied Chem. Vol. 31, p. 578 (1972).). A metal can also be included in the constituting components of porous materials, and recently, an organic-inorganic hybrid material comprising both an organic material and an inorganic material has been classified as the porous material materials (Angew. Chem. Intl. Ed, vol. 43, p. 2334 (2004); Chem. Soc. Rev., vol. 32, p. 276 (2003); Microporous Mesoporous Mater., vol. 73, p. 15 (2004)). Such material has a structure where such components as a transition metal and lanthanum (La), in addition to said silicon, aluminum, and phosphorus, share oxygen or an organic substance to form a three-dimensional structure, and the porous material has pores of a special size and shape depending on synthetic conditions (Chem. Review vol. 99, p. 635, 1999; U.S. Pat. No. 4,567,029). Such porous materials are generally prepared through a hydrothermal or solvo-thermal synthesis which carries out a reaction at high temperature (generally 50 to 300° C.) using water or organic substance as a solvent.

The porous material is mainly synthesized using water or proper organic material as a solvent under autogenous pressure caused by high temperature. Mixed metal oxides can also be prepared by several processes, however, these can be obtained at high temperature in the presence of a solvent. Until now, electric heating has been generally used as a heat source for obtaining the high temperature in preparing the porous materials and the mixed metal oxides. In other words, the reaction for preparing these materials has been performed either by charging reaction materials into a pressure reactor, tightly closing the reactor and then heating the reactor using an electric furnace, or by charging reaction materials into a pressure vessel and placing the pressure vessel into an electric oven which can be controlled at a constant temperature. Such synthesis generally requires a reaction time of a few days or longer at high temperature, and thus requires excessive energy, and carries out the reaction only in a batch process, leading to a very low production efficiency.

Also, since 1988 there has been known some of technologies for preparing porous materials using microwaves as a heat source 1988 (U.S. Pat. No. 4,778,666; Catalysis Survey Asia vol. 8, p. 91, 2004). In many cases, the reaction time in the synthesis of porous materials and mixed metal oxides using microwaves could be shortened by controlling reaction conditions in a manner similar to the synthesis of other materials. However, the synthesis of porous materials and mixed metal oxides has been carried out in a batch process. The continuous synthesis of materials, including porous materials and mixed metal oxides, is a technology highly necessary for increasing productivity, automation, and economy, however, it has not almost been known.

Further, even since it was reported that a hydrothermal reaction was continuously carried out by controlling necueation and crystal growth rates (Zeolites, vol. 15, p. 353, 1995), the technology of continuously preparing porous materials by electric heating has not been developed due to a long reaction time. Then, methods of synthesis using microwaves have been attempted and a number of reports on this synthesis have been suggested, however, these reports were mainly results obtained at a low temperature below 100° C. or by the use of reactors having a very long coil shape. For instance, although the results of synthesis of AlPO-5 using a tubular coil reactor (Microporous Mesoporous Materials vol. 23, p. 79, 1998) and of synthesis of a several porous materials and inorganic materials (Korea patent registration No. 10-0411194, and Japan patent registration No. 3526837) have been known, but these synthetic methods have problems in that the use of the very long coil-type reactor can cause a very high differential pressure in the reactor, and makes the control of temperature and pressure difficult, leading to the explosion of the reactor or a severe fluctuation in reaction temperature and pressure. Meanwhile, there was reported an example where a reaction is performed by irradiation of microwaves while moving reactants (U.S. Pat. No. 6,663,845B1). However, in this case, the reaction temperature should necessarily be very low, because it is impossible to avoid the evaporation of a solvent at a temperature above the boiling point of the solvent.

In the synthesis of porous materials and mixed metal oxides according to the present invention, microwave energy is used as a heat source, and a tubular reactor is used, in which the pressure within the reactor is controlled by separating solid and liquid phases from a reaction product and then measuring the pressure of the remaining gas phase, and sensors for measuring reaction temperature and pressure are placed at a region which is not irradiated with the microwaves. Although the measuring position is outside of the reactor in which the reaction is carried out, the difference between the measured value and the actual reaction temperature is not great to cause a problem because the reaction tube is short. Further, the tubular reactor is constructed such that a region to be irradiated with microwaves is free of a joint (connection portion), thereby increasing safety. Also, if a long residence time is required, the tubular reactors connected with each other in series are used, and if productivity per time is to be increased, the tubular reactors connected in parallel are used. However, in such cases, the connection portions between the reactors are all positioned at a region, which is not irradiated with microwaves. Also, a rupture is disposed at the connection portions to prevent explosion caused by a rapid increase in pressure. Using such construction of the continuous reactors, the present inventors have developed a method for preparing porous materials and mixed metal oxides, which has increased operation stability and reproducibility, can easily control the residence time in the reactor, and can achieve an increase in productivity, thereby completing the present invention.

Porous materials have very broad applicability because they can be used for catalysts, catalytic supports, adsorbents, ion exchange and gas storage, and also can be used in the storage, synthesis and separation of nanosized materials, and can be used as nanosized reactors. Also, the use of mixed metal oxides, including perovskite, has been progressively enlarged as it is used as an electronic ceramic material, a functional material, a catalyst, and the like. Accordingly, it has been very strongly required to develop a technology of preparing porous materials and mixed metal oxides by a short-time reaction, and more preferably in a continuous manner.

### DISCLOSURE

### Technical Problem

Therefore, the present invention has been made in view of the above problems occurring in the prior art, and it is an object of the present invention to develop a technology of continuously preparing materials, including porous materials and mixed metal oxides, which is carried out in a stable manner and easily controls temperature and pressure, as well as an reaction apparatus for conducting this synthesis.

### Technical Solution

The present invention has been intended to develop an effective method for preparing materials, including porous materials and mixed metal oxides, and a continuous reaction apparatus for carrying out the method, and is characterized by continuously preparing materials, including porous materials and mixed metal oxides, using microwave energy as a heat source for reaction. Hereinafter, the present invention will be described in further detail.

Porous materials can comprise a metal component in addition to silicon, aluminum and phosphorus. Said silicon, aluminum and phosphorus, which are the main constituent elements of the porous material, can be obtained from any precursors. However, in view of convenience and cost, they are preferably obtained from silica, fumed silica, silica sol, water glass, tetraethylorthosilicate (TEOS), tetramethylorthosilicate (TMOS), sodium silicate, alumina, sodium aluminate, alumino-silicate, aluminum alkoxide, and phosphoric acid. The alumina can be of any structure, and preferably has the pseudoboehmite and boehmite structures. As the phosphoric acid, a phosphoric acid having a purity of about 85 wt % is most preferable. As the metal source, any metal can be used, and a transition metal, a main group element and lanthanum (La) can be used. Among the transition metals, titanium, vanadium, chromium, manganese, iron, cobalt, nickel, copper, zinc, and the like can preferably be used. Among the main group elements, boron and gallium are proper, and among the lanthanum (La) group metals, cerium and lanthanum are proper. As the metal source, not only a metal itself, but also any metal compound, can be used. Especially, nitrate, chloride, acetate, sulfate, carbonate, oxides, and hydroxides can be used. In addition to the metallic components, elements serving to link a metal with another metal or positioned between metals, such as oxygen and sulfur, can be used, and an organic substance, called a linker, can also be used.

As the linker, any organic substance which has a site for coordination, such as —CO₂⁻, —CS₂⁻, —SO₃⁻, or —N, can be used. In order to induce a stable organic-inorganic hybrid, it is preferable to use organic substances (such as bidentate, tridentate, and the like) having at least two coordination sites. As for the organic substances, neutral substances (such as bipyridine, pyrazine, and the like), anionic substances (anions of carboxylic acid, such as terephthalate and glutarate), and cationic substances, can be used as long as they have a coordination site. As for the carboxylic acid anions, any anion selected from anions having an aromatic ring, such as terephthalate, anions of linear carboxylic acid, such as formate, and anions having a non-aromatic ring, such as cyclohexyldicarbonate, can be used. Not only the organic substances having sites for coordination, but also substances which have potential coordination sites and thus can be coordinated in reaction conditions, can also be used. In other words, when organic acid such as terephthalic acid is used, it can be converted into terephthalate during reaction so as to be able to combine with a metallic component. Typical examples of the organic substances, which can be used in the present invention, include organic acids such as benzene dicarboxylic acid, naphthalene dicarboxylic acid, benzene tricarboxylic acid, naphthalene tricarboxylic acid, pyridine dicarboxylic acid, bipyridyl-dicarboxylic acid, formic acid, oxalic acid, malonic acid, succinic acid, glutaric acid, hexandioic acid, heptandioic acid, and anions thereof, pyrazine, bipyridine, and the like. Also, said organic substances can be used in a mixture of at least two thereof.

In the synthesis of some of porous materials, a nitrogen-containing organic substance, called “template”, is required to obtain porosity. It acts as a mold for porous material, and suitable examples thereof include amines or ammonium salts. As the amines, monoamines, diamines and triamines can be used. Examples of the monoamines, which can be used in the present invention, include tertiary amines such as triethylamine, tripropylamine, diisopropylamine, triethanolamine, secondary amines such as dibutylamine, dipropylamine, and the like, and primary amines such as heptylamine, octylamine, nonylamine, and the like, and cyclic amines such as morpholine, cyclohexylamine, pyridine, and the like. Examples of the diamines, which can be used in the present invention, include diaminoethane, diaminopropane, diaminobutane, diaminoheptane, diaminohexane, and the like, but are not limited thereto. Examples of the ammonium salt, which can be used in the present invention, include tetramethylammonium hydroxide, tetraethylammonium hydroxide, tetrapropylammonium hydroxide, tetrabutylammonium hydroxide, tetramethylammonium chloride, tetraethylammonium chloride, tetrapropylammonium chloride, tetrabutylammonium chloride, tetramethylammonium bromide, tetraethylammonium bromide, tetrapropylammonium bromide, tetrabutylammonium bromide, tetramethylammonium fluoride, tetraethylammonium fluoride, tetrapropyl-ammonium fluoride, tetrabutylammonium fluoride, and the like. In addition to said silicon, aluminum, phosphorus and metal components, oxygen or linker material, and template, a suitable solvent is required in the synthesis of the porous materials. Examples of the solvent, which can be used in the present invention, include water, alcohols (e.g., methanol, ethanol, propanol, and the like), ketones (e.g., acetone, methylethylketone, and the like), and hydrocarbons (e.g., hexane, heptane, octane, and the like). These solvents may also be used in a mixture of two or more thereof, and water is most preferable.

Porous materials to be synthesized in the present invention can be any compositions and structures, such as microporous materials, mesoporous materials, organic-inorganic hybrids, and the like. However, special examples of the porous materials to be synthesized in the present invention include phosphate molecular sieves, including AEL, CHA and AFI (Atlas of Zeolite Structure Types, Elsevier, London, p. 20, p. 76 and p. 26, 1996), zeolites, such as LTA, FAU and MFI (Atlas of Zeolite Structure Types, London, p. 130, p. 104, and p. 146, 1996), mesoporous materials such as SBA, nickel phosphate microporous materials, including VSB-1 (C. R. Acad. Sci. Paris vol. 2, p. 387, 1999) and VSB-5 (Angew. Chem. Intl. Ed. Vol. 40, p. 2831, 2001), and organic-inorganic hybrids, MIL-77 (Angew. Chem. Intl. Ed. Vol. 42, p. 5314, 2003).

The AEL structures have a pore consisting of 10 oxygen atoms (existing between metal, aluminum or phosphorus atoms), include SAPO-11, AlPO-11 and the like, and can be used as cracking catalysts. The CHA structures have a relatively small pore consisting of eight oxygen atoms (existing between metal, aluminum or phosphorus atoms), and include SAPO-34, CoAPO-34, MnAPO-34 and the like, and are used as commercial catalysts in a process of preparing olefin from methanol. The AFI structures have a pore consisting of twelve oxygen atoms (existing between metal, aluminum or phosphorus atoms), and include AlPO-5, SAPO-5, VAPO-5, CoAPO-5, and FAPO-5 and the like, and are used to prepare various nanosized materials (Nature, vol. 408, p. 50, 2000). The LTA structure has a framework containing silicon and aluminum, which share oxygen atoms, and it has a relatively small pore consisting of eight oxygen atoms and is mainly used as a detergent builder and an adsorbent. The FAU structure has a framework containing silicon and aluminum atoms, which share oxygen atoms, and it has a relatively large pore consisting of twelve oxygen atoms and is used as an adsorbent and a catalyst in the petrochemical industry. The MFI structures have a pore consisting of ten oxygen atoms (existing between metal, aluminum or phosphorus atoms), and include ZSM-5, silicalite-1, TS-1 and the like, and are variously used as a catalyst and a separating agent in several chemical processes.

The SBA-16 structure is amorphous SiO₂ with an Im3m space group consisting of a three dimensional network of Si—O—Si (J. Am. Chem. Soc. Vol. 120, p. 6024-6036, 1998). Unlike zeolites, it generally uses a surfactant as a material for maintaining the structure thereof, typical examples of which include polymers such as Pluronic F127, F108 and P123. The SBA-16 has a high specific surface area of about 400-1000 m²/g. The SBA-16 has a cage-like structure with an entrance size above 4 nm and pore size of 10 nm, compared to MCM mesoporous materials. Further, it has wall thickness of about 4-10 nm, and thus increased thermal stability compared to existing materials, and is widely used not only as catalysts, but also as carriers for preparing functional carbonic materials. Recently, it has been applied as sensor materials for detecting gaseous compounds and for the support and separation of biochemical molecules. The MIL-77 is an organic-inorganic hybrid composed of nickel and glutaric acid, and is a micro-porous material, which will be broadly used in the future, because it has a chiral structure and special magnetic properties.

Perovskite, which is one of mixed metal oxides, is an inorganic material having a composition of ABO₃, wherein A has the octagonal coordination and B has the dodecagonal coordination. Typical examples thereof include BaTiO₃, SrTiO₃, PbZrO₃, BaZrO₃, LaAlO₃, KNbO₃, and the like, and it is widely used as electronic ceramics. The mixed metal oxides can be prepared through several processes, particularly a hydrothermal synthetic method which is carried out at high temperature in the presence of a solvent. In recent, BaTiO₃, which can be used in a multi-layer ceramic condenser, and the like, has also been frequently prepared through the hydrothermal synthetic method instead of a high-temperature calcination process. As the source of barium in the BaTiO₃, any material can be used; however, barium chloride, barium fluoride, barium nitride, barium hydroxide, and the like can be easily used. As the source for titanium, any material can be used; however, titanium chloride, titanium hydroxide, titanium oxide, tetraethylorthotitanate, and the like can be easily used. As a mineralizer, any base can be used without any particular limitation so far as it is a strong base. Sodium hydroxide or potassium hydroxide can be easily used as the mineralizer.

The present invention is characterized by using microwaves instead of general electric heating as a heat source for high-temperature reaction. In this regard, any microwave having a frequency ranging from about 1000 MHz to 30 GHz can be used to heat reactants, however, it is simple and efficient to use industrial microwaves having frequencies of 2.45 and 0.915 GHz, and the like.

Hereinafter, the continuous reaction apparatus of the present invention will be described with reference to the appended drawings.

FIG. 1 is a diagrammatic view for showing the simplified structure of the continuous reaction apparatus of the present invention. As shown in FIG. 1, the apparatus of the present invention comprises a reactant drum 10 for stirring and storing reactants, a slurry pump 11 for transporting the reactant slurry stored in the reactant drum, a pre-heater 20, a tubular reactor 30, a temperature measuring and controlling unit 33, a cooler 40, a product drum 41 for storing a product, and a pressure measuring and controlling unit 42.

Raw materials can be metered and stirred in the reactant drum 10, and the reactants can be continuously supplied using the slurry pump 11. The supplied reactants are preheated at the pre-heater 20 to the maximum reaction temperature, and the pre-heating can be achieved using microwave or an electric heater. The tubular reactor 30 is made of a material permeable to microwaves, such as Teflon, ceramic and the like, with Teflon being advantageous in terms of workability. The tubular reactors 30 can be connected in series in order to increase the residence time therein and can be connected in parallel in order to improve productivity. In FIG. 1, the two tubular reactors 30 are connected in series. As an example for the source for providing microwaves to the tubular reactor, a structure using a microwave oven 31 is shown in FIG. 1. When the microwave oven is used, the microwaves can be relatively uniformly distributed in the oven, so that the microwaves can be uniformly irradiated into the tubular reactor.

FIG. 2 is a conceptual view showing only the surrounding of reactors in a view illustrating the concept of using three commercial magnetrons 32 to irradiate the microwaves to the reaction apparatus consisting of three tubular reactors 30 connected in series. In FIG. 2, a distributor (not shown) is placed such that the microwaves can be uniformly irradiated into the region of the reactor, and the outside of the tubular reactor is wound by tubular ceramic insulation material 36 in order to prevent heat loss. As shown in FIG. 2, in order to control reaction, a temperature sensor 33 and a pressure sensor 35 can be located at the connection portion between the reactors, into which the microwave is not irradiated. Also, the connection portion is formed with a portion at which a rupture 34 can be placed so that explosion does not occur in spite of the rapid change in pressure.

When several reactors are connected with each other, they can be connected in a horizontal direction, and they can also be connected so that the reactants can flow in the upward direction or downward direction. If they flow in the upward direction, process stability becomes good, but plugging of the reactors can frequently occur if the solid concentration in the reactants is high or the viscosity of the reactants is high. On the other hand, if they are made to flow downward, the plugging problem will decrease, but the operational stability of the process will be decreased because the flow of the reactant is not uniform. Thus, the flow direction of the reactants should be selected in consideration of the viscosities and concentrations of the reactant and product, and the horizontal flow is appropriate. After completion of the reaction, the product is cooled, and the solid and liquid of the product are collected in the product drum 41, and the gas of the product is vented through a pressure controller 42. If a larger scale of production is required, it will be more preferable that a separation tank (not shown) capable of separating the solid from the liquid be disposed in place of the product drum 41, and the liquid be removed using the separation tank, after which the product be dried and packaged. In the pressure controller, the pressure of gas can be precisely measured without the interference of solid or liquid, and the measured pressure indicates the pressure of the reactor, and thus the pressure within the reactor can be controlled in a very stable manner.

The pressure of the reactor is not substantially limited, but is preferably below 500 psi, and it is simple to carry out the synthesis of the product at the autogenous pressure of the reactants at the reaction temperature. Also, in the initial stage of the reaction, if the reaction is initiated at high pressure obtained by adding inert gas such as nitrogen or helium, the evaporation of a solvent will not occur so that a stable operation can be secured.

The reaction temperature is not limited to any particular temperature, but is preferably more than 50° C., and more preferably 100-250° C. If the temperature is too low, the reaction rate will undesirably be low, and if the reaction temperature is too high, non-porous material tends to be obtained and impurities tend to be incorporated because the reaction rate is too fast. Also, this high temperature will result in an increase in the pressure within the reactor to make the construction of the reactor difficult, and will also be uneconomical.

The residence time in each of the reactors is preferably about one minute to one hour. If the residence time is too long, productivity becomes low, and if the residence time is too short, reaction conversion will be decreased. The residence time in each reactor is more preferably 1-20 minutes.

The length of the tubular reactor is preferably 5-100 cm per magnetron (microwave generator). If the reactor length is too short, a plurality of reactors will be undesirably required, and if it is too long, differential pressure tends to be generated and the construction of the reactor becomes inefficient.

Because the reaction by microwaves takes place very rapidly, it is preferable to stir and mix the reactants sufficiently before the reaction. Especially, it is preferable to preheat the reactants at the temperature between room temperature and the reaction temperature.

### DESCRIPTION OF DRAWINGS

The above and other objects, features and advantages of the present invention will be apparent from the following detailed description of the preferred embodiments of the invention in conjunction with the accompanying drawings, in which:

FIG. 1 is a schematic view for showing the construction of an apparatus for continuously preparing porous materials and mixed metal oxides using a microwave energy;

FIG. 2 is a view for showing a construction around a continuous reactors of the present invention, comprising three tubular reactors connected in series, in which the temperature of the reactant can be maintained by irradiating microwaves from a commercial magnetron into the tubular reactors;

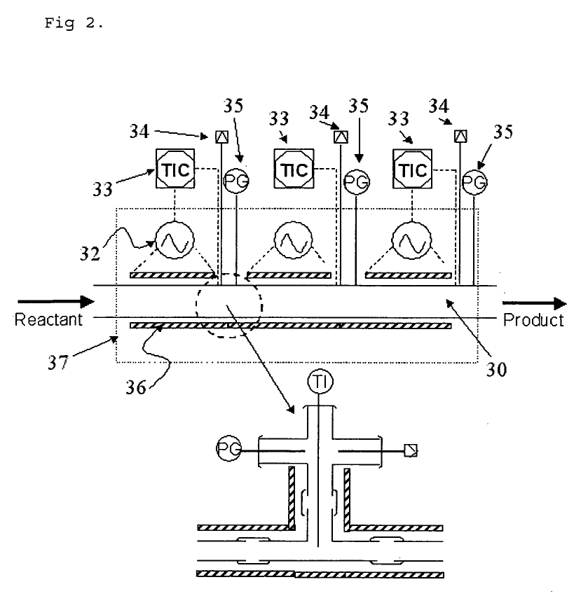

FIG. 3 shows the X-ray diffraction pattern of a nickel phosphate having a VSB-5 structure, in which (a), (b), (c) and (d) correspond to the x-ray diffraction patterns of materials obtained in example 1, example 2, comparative example 1, and comparative example 2, respectively;

FIG. 4 shows the x-ray diffraction pattern of a nickel-phosphate having a VSB-1 structure, in which (a) and (b) correspond to the x-ray diffraction patterns of materials in example 3 and example 4, respectively;

FIG. 5 shows the x-ray diffraction pattern of an aluminophosphate having an AlPO-5 structure, which corresponds to the x-ray diffraction pattern of a material in example 7; and

FIG. 6 shows the x-ray diffraction pattern of a nickel-glutarate having a MIL-77 structure, which corresponds to the x-ray diffraction pattern of a material in example 8.

### DESCRIPTION OF REFERENCE NUMERALS USED IN THE DRAWING

10: reactant drum 11: slurry pump

20: pre-heater 21: pressure gauge

22: thermocouple 30: tubular reactor

31: microwave oven 32: microwaves

33: temperature measuring and controlling unit

34: rupture 35: pressure gauge

36: insulating material 37: microwave shield

40: cooler 41: product drum

42: pressure measuring and controlling unit

43: exhaust port 44: nitrogen tank

### MODE FOR INVENTION

Hereinafter, the present invention will be described in more detail with reference to the following examples. It is to be understood, however, that these examples are not to be construed to limit the present invention.

### EXAMPLES

### Example 1

### VSB-5

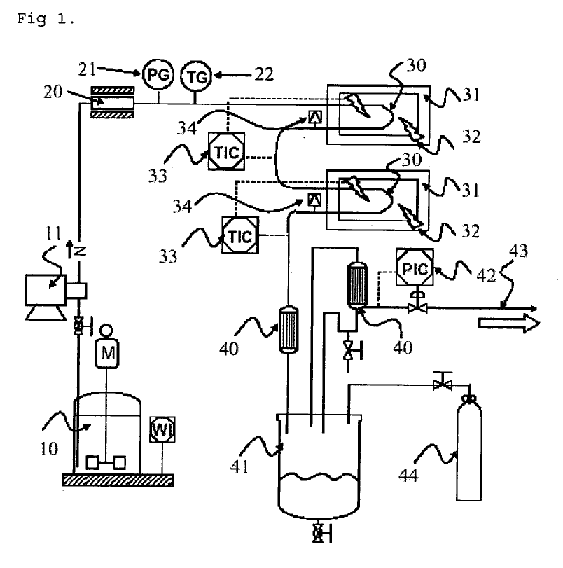

1) Preparation apparatus: the apparatus shown in FIG. 1 is used to prepare materials, including porous materials and mixed metal oxides. Reactants can be metered into the reactant drum 10 to make a reaction mixture, and the reaction mixture can be transported to the pre-heater 20, the microwave reactor 30, the cooler 40, and the product drum 41 using the slurry pump 11. Also, a pressure gauge 21 and a thermocouple 22 are mounted at a region which is not irradiated with microwaves, such that the temperature and pressure of the reactant or product can be measured. The temperature of reaction can be controlled by adjusting the electric power of microwaves, and the rupture 34 was provided such that the reactor can be automatically vented if the rapid increase in pressure occurs. This can prevent pressure increase and explosion in the reactor. The product drum 41 can collect the products and can control the pressure of the reactor by measuring the pressure of gas from which solid and liquid have been removed, and pressure above the set pressure can be vented to the outside via the pressure controller 42. It is preferable to maintain the pressure of the reactor to a set value before the initiation of reaction in order to prevent the evaporation of the solvent and to make the reaction smooth and stable. For this purpose, the nitrogen tank 44 can be used. Further, a stainless steel mesh can be mounted around the reactor to prevent microwaves from leakage.

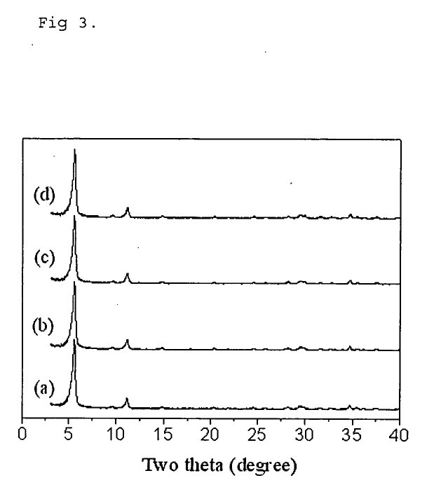

2) Preparation experiment: nickel chloride hexahydrate was dissolved in distilled water, to which phosphoric acid (85) was then added dropwise, followed by the addition of ammonia water (28%), thus making a composition of NiCl₂:0.315P₂O₅:3NH₃:100H₂O. The composition was well stirred to make a uniform reaction solution. After charging the reaction apparatus shown in FIG. 1 with nitrogen to a pressure of 145 psi, the reaction solution was continuously fed into the reaction apparatus by pumping. The temperature of the reaction solution passed through the pre-heater with electric heating was 90° C. The temperature of a reaction product mixture passed out through the microwave oven was adjusted to 180° C. by controlling the power of the microwave oven, and if the pressure of the reactor exceeded 145 psi, gas was vented from the reactor. The residence time in each of the reactors was 1.5 minutes, and the product was collected in the product drum from 30 minutes after the initiation of the reaction, and the product was cooled, and solid and liquid was separated from the product. The product was dried. From the x-ray diffraction pattern (FIG. 3a) of the obtained product, it could be observed that the obtained material was a nickel-phosphate microporous material having a VSB-5 structure. The BET surface area measured after maintaining the dried material at 300° C. for four hours was 400 m²/g, and detailed experiment conditions and the physical properties of the obtained material are shown summarized in table 1 below. It can be seen that the porous material obtained by continuous synthesis in this Example has substantially the same physical properties and structure as those of a material obtained by a batch-type microwave heating process in Comparative Example 1 below. This suggests that, by the preparation apparatus comprising the continuous tubular reactors as described in this Example, a microporous material having excellent physical properties can also be prepared in a very effective manner. Also, it can be seen that this Example had a very fast synthesis rate and very high productivity compared to electric oven heating described in comparative example 2 below.

### Example 2

### V-VSB-5

This Example was carried out in a manner similar to Example 1, however, vanadyl sulphate tetrahydrate was used in addition to nickel chloride hexahydrate. In other words, the reactants had a composition of NiCl₂:0.033VOSO₄:0.31P₂O₅:3NH₃:100H₂O. From the x-ray diffraction pattern of the product, shown in FIG. 3b, it can be seen that V-VSB-5 was obtained. Detailed experimental conditions and the physical properties of the obtained material are shown in table 1 below.

### Comparative Example 1

### VSB-5 Batch

Synthesis was performed in a manner similar to Example 1, however, a batch microwave reactor was used instead of the continuous reactor. In other words, the VSB-5 porous material was synthesized by charging 40 g of the reactant into a Teflon reactor, tightly closing the reactor, and mounting the Teflon reactor to a microwave reactor (Mars-5, CEM corporation), elevating the temperature of the reactor to 180° C. and maintaining the reactor at that temperature for three minutes. From the x-ray diffraction pattern (FIG. 3c) of the product, it can be seen that VSB-5 was obtained. Detailed experiment conditions and the physical properties of the obtained material are summarized in table 1.

### Comparative Example 2

### VSB-5, Conventional Electric Heating

Synthesis was performed in a manner similar to Comparative Example 1, however, general electric oven was used instead of microwaves as a heat source, and the batch-type reactor was used instead of the continuous reactor. The VSB-5 porous material was synthesized by maintaining the reactants at 180° C. for three hours. From the x-ray diffraction pattern (FIG. 3d) of the product, it can be seen that VSB-5 was obtained. Detailed experiment conditions and the physical properties of the obtained material are summarized in table 1.

### Example 3

### VSB-1

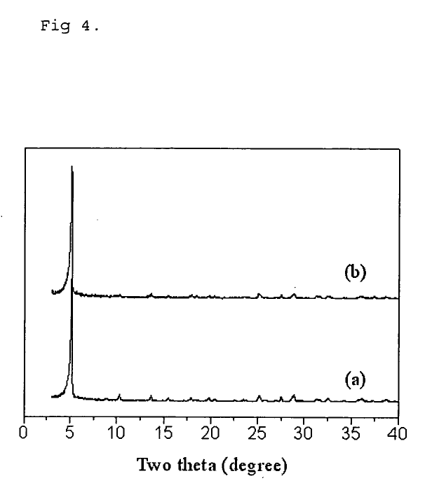

Reaction was performed in a manner similar to Example 1, however, acidic reactant containing a fluorine component was used as a raw material, and the reactant had a composition of NiCl₂:0.5P₂O₅:2.5NH₄F:100H₂O. The residence time in each of the reactors was five minutes. From the x-ray diffraction pattern (see FIG. 4a) of the product, it can be seen that a VSB-1 structure was obtained. Detailed experiment conditions and the physical properties of the obtained material are summarized in table 1.

### Example 4

### Fe-VSB-1

Reaction was performed in a manner similar to Example 2, however, iron-containing nickel phosphate was prepared, and the composition of the reactant was NiCl₂:0.5P₂O₅:0.233FeCl₂:2.5NH₄F:100H₂O. The residence time in each of the reactors was five minutes. From the x-ray diffraction pattern (FIG. 4b) of the obtained product, it can be seen that the iron-containing nickel phosphate Fe-VSB-1 was obtained. Detailed experiment conditions and the physical properties of the obtained material are summarized in table 1.

### Example 5

### SAPO-11

Distilled water was added to phosphoric acid (85 wt %) to a phosphoric acid concentration of 42.5%, pseudobohemite was added thereto, and silica sol (40 wt % aqueous solution), di-n-prophylamine (DPA), and distilled water were sequentially added thereto to form a composition of Al₂O₃:1.0P₂O₅:0.2SiO₂:1.5DPA:100H₂O. The reaction solution was thoroughly stirred to form uniform reaction gel. The reaction gel was allowed to react in a manner similar to Example 1, however, the residence time in each of the reactors was 2.5 minutes. The obtained product was dried. From the x-ray diffraction pattern of the product, it can be seen that the obtained material was SAPO-11 having an AEL structure. The BET surface area measured after calcining the dried sample at 550° C. for 10 hours was 300 m²/g, and detailed experiment conditions and the physical properties of the obtained material are summarized in table 1.

### Example 6

### SAPO-34

Reaction was performed in a manner similar to Example 5, except that the number of the connected reactors was three instead of two, and N,N-dimethyl-1,3-propanediamine (DMPDA) was used as template, and the residence time in each of the reactors was 5 minutes. The reaction temperature was maintained at 185° C., and the reaction pressure was maintained at 163 psi. In other words, the reactant had a composition of Al₂O₃:1.0P₂O₅:0.1SiO₂:1.0DPA:100H₂O. From the x-ray diffraction pattern of the product, it can be seen that SAPO-34 was obtained. Detailed experiment conditions and the physical properties of the obtained material are summarized in table 1.

### Example 7

### AlPO-5

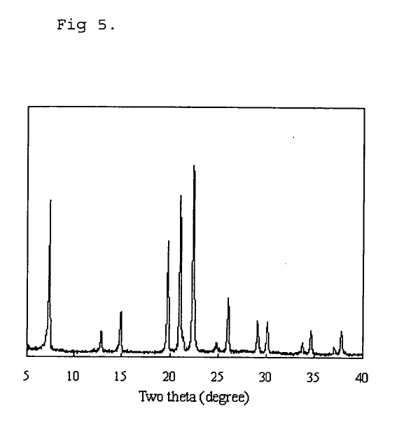

Reaction was performed in a manner similar to Example 5, however, triethylamine (TEA) was used as the template, and the composition of the reactant was made to be Al₂O₃:1.05P₂O₅:1.2TEA:100H₂O, and the residence time in each of the reactors was seven minutes. From the x-ray diffraction pattern (FIG. 5) of the product, it can be seen that AlPO-5 was obtained. Detailed experiment conditions and the physical properties of the obtained material are summarized in table 1.

### Example 8

### MIL-77

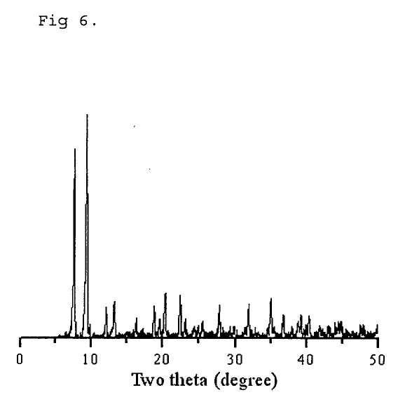

Reaction was performed in a manner similar to Example 1, but an organic-inorganic hybrid was prepared. As reactants, nickel-chloride hexahydrate, glutaric acid, iso-propyl acid (IPA), potassium chloride and distilled water were used. The reactants had a composition of NiCl₂:1.5GTA:1.0KOH:9.01PA:30H₂O. The residence time in each of the reactors at 180° C. was maintained at 2.5 minutes. From the x-ray diffraction pattern (FIG. 6) of the obtained product, it could be observed that an organic-inorganic hybrid MIL-77 structure was obtained. Detailed experiment conditions and the physical properties of the obtained material are summarized in table 1.

### Example 9

### ZSM-5

Reaction was performed in a manner similar to Example 1 to prepare zeolite ZSM-5. Due to low reaction rate, a seed was first prepared. Then, the seed was added to reactants to carry out reaction. To prepare the seed, tetraethylorthosilicate, tetrapropylammoniumhydroxide (TPAOH) and distilled water were used to make a reaction gel having a composition of SiO₂:0.2TPAOH:20H₂O. The gel contained ethanol due to the hydrolysis of tetraethylorthosilicate. The gel was maintained at 80° C. for one hour to remove the ethanol. Then, the gel was allowed to react at 165° C. for ten minutes in the microwave reaction apparatus used in Comparative Example 1 to thereby obtain the seed. The seed for obtaining zeolite ZSM-5 was of a spherical shape of less than about 100 nm when it was analyzed after the removal of the liquid and drying. In order to obtain the ZSM-5 microporous material, silica sol, sodium aluminate, potassium hydroxide and distilled water were used to prepare a reaction gel having a composition of SiO₂:0.02Al₂O₃:0.25NaOH:60H₂O. Then, the above-prepared seed-containing liquid (5% of total silica) was added to the reaction gel (95% of total silica). The mixture was maintained at a reaction temperature of 165° C. and a pressure of 102 psi, similar to Example 1. However, three reactors were connected in series in a manner similar to Example 6, and the residence time in each of the reactors was five minutes. From the x-ray diffraction pattern of the product, it can be seen that ZSM-5 was obtained. Detailed experiment conditions and the physical properties of the obtained material are summarized in table 1.

### Example 10

### SBA-16

Reaction was performed in a manner similar to Example 1 to prepare SBA-16 having mesopores and a cubic structure. As reaction raw materials, sodium metasilicate nonahydrate (Na₂SiO₃9H₂O), hydrochloric acid, triblock copolymer (Pluronic F127; EO₁₀₆PO₇₀EO₁₀₆) and distilled water were used, and the composition of the reactants were SiO₂:3.2×10⁻⁴F127:7HCl:150H₂O. The reaction gel was aged wit stirring for thirty minutes, and an apparatus similar to the reaction apparatus of Example 1 was used, and the number of the connected reactors was three. The temperature of the reactant passed through the pre-heater was 60° C., and the residence time in each of the reactors was maintained at seven minutes, and the reaction temperature was 100° C. and the pressure was less than 15 psi. From the x-ray diffraction pattern of the product, it can be seen that SBA-16 micro-porous material having a cubic structure was obtained. Detailed experiment conditions and the physical properties of the obtained material are summarized in table 1.

### Example 11

### BaTiO₃

Reaction was performed in a manner similar to Example 1 to prepare perovskite-type inorganic material BaTiO₃, which is one of mixed metal oxides. As reactants, titanium chloride, barium chloride, potassium hydrate and distilled water were used, and the composition of the reactants was TiCl₄:2.0BaCl₂:3.0KOH:300H₂O. The residence time in each of the reactors at 180° C. was maintained at five minutes. From the x-ray diffraction pattern of the obtained product, it can be seen that the perovskite-type BaTiO₃ structure was obtained. Detailed experiment conditions and the physical properties of the obtained material are summarized in table 1.

TABLE 1
Conditions and results of reaction

| | Conditions of reaction | | | | | | | | |
|---|---|---|---|---|---|---|---|---|---|
| | | | | | Residence time or | | | Results of | |
| | Composition | Heating and | Temperature | Number | reaction time(minute) | | | reaction | |
| Example | of reactants | preparation | of reaction | of | 1^{st} | 2^{nd} | 3^{rd} | Obtained | |
| No. | (mol ratio) | method^{b} | (° C.) | reactors | reactor | reactor | reactor | structure | S_{BET}^{c} |
| 1 | NiCl₂: | CMW | 180 | 2 | 1.5 | 1.5 | | VSB-5 | 400 |
| | 0.315P₂O₅: | | | | | | | | |
| | 3NH₃: | | | | | | | | |
| | 100H₂O | | | | | | | | |
| 2 | NiCl₂: | CMW | 180 | 2 | 1.5 | 1.5 | | V-VSB-5 | 400 |
| | 0.033VOSO₄: | | | | | | | | |
| | 0.315P₂O₅: | | | | | | | | |
| | 3NH₃: | | | | | | | | |
| | 100H₂O | | | | | | | | |
| Comparative | NiCl₂: | BMW | 180 | 2 | 3 | | | VSB-5 | 390 |
| example 1 | 0.315P₂O₅: | | | | | | | | |
| | 3NH₃: | | | | | | | | |
| | 100H₂O | | | | | | | | |
| Comparative | NiCl₂: | CE | 180 | 2 | 180 | | | VSB-5 | 400 |
| example 2 | 0.315P₂O₅: | | | | | | | | |
| | 3NH₃: | | | | | | | | |
| | 100H₂O | | | | | | | | |
| 3 | NiCl₂: | CMW | 180 | 2 | 5 | 5 | | VSB-1 | 180 |
| | 0.5P₂O₅: | | | | | | | | |
| | 2.5NH₄F: | | | | | | | | |
| | 100H₂O | | | | | | | | |
| 4 | NiCl₂: | CMW | 180 | 2 | 5 | 5 | | Fe-VSB-1 | 180 |
| | 0.5P₂O₅: | | | | | | | | |
| | 0.233FeCl₂: | | | | | | | | |
| | 2.5NH₄F: | | | | | | | | |
| | 100H₂O | | | | | | | | |
| 5 | Al₂O₃: | CMW | 180 | 2 | 2.5 | 2.5 | | SAPO-11 | 300 |
| | 1.0P₂O₅: | | | | | | | | |
| | 0.2SiO₂: | | | | | | | | |
| | 1.5DPA: | | | | | | | | |
| | 100H₂O | | | | | | | | |
| 6 | Al₂O₃: | CMW | 185 | 3 | 5 | 5 | 5 | SAPO-34 | 650 |
| | 1.0P₂O₅: | | | | | | | | |
| | 0.1SiO₂: | | | | | | | | |
| | 1.0HF: | | | | | | | | |
| | 1.5DMPDA: | | | | | | | | |
| | 100H₂O | | | | | | | | |
| 7 | Al₂O₃: | CMW | 180 | 2 | 7 | 7 | | AlPO-5 | 320 |
| | 1.05P₂O₅: | | | | | | | | |
| | 1.2TEA: | | | | | | | | |
| | 100H₂O | | | | | | | | |
| 8 | NiCl₂: | CMW | 180 | 2 | 2.5 | 2.5 | | MIL-77 | 270 |
| | 1.5GTA: | | | | | | | | |
| | 1.0KOH: | | | | | | | | |
| | 9.0IPA: | | | | | | | | |
| | 30H₂O | | | | | | | | |
| 9 | SiO₂: | CMW | 16 | 3 | 5 | 5 | 5 | ZSM-5 | 430 |
| | 0.019Al₂O₃: | | | | | | | | |
| | 0.2375NaOH: | | | | | | | | |
| | 0.01TPAOH: | | | | | | | | |
| | 58H₂O | | | | | | | | |
| 10 | SiO₂: | CMW | 100 | 3 | 7 | 7 | 7 | SBA-16 | 440 |
| | 3.2 × 10⁻⁴ | | | | | | | | |
| | F127:7HCl: | | | | | | | | |
| | 150H₂O | | | | | | | | |
| 11 | TiCl₄: | CMW | 180 | 2 | 5 | 5 | | BaTiO₃ | ND^{d} |
| | 2.0BaCl₂: | | | | | | | | |
| | 3.0KOH: | | | | | | | | |
| | 300H₂O | | | | | | | | |

^{a}DPA: di-n-propyl amine; TEA: triethylamine; DMPDA: N,N-dimethyl-1,3-propanediamine; IPA: iso-propyl amine; GTA: glutaric acid
^{b}CMW: continuous microwave heating; BMW: batch-type microwave heating; CE: conventional electric oven heating.
^{c}BET surface area (m²/g); VSB-5, V-VSB-5, VSB-1, Fe-VSB-1 were measured after evacuation in vacuum at 300° C., MIL-77 was measured after evacuation in vacuum at 200° C., the remainder was measured after calcination at 550° C. in air and evacuation in vacuum at 300° C..
^{d}ND; not measured

### INDUSTRIAL APPLICABILITY

As described above, in the preparation of materials, including porous materials and mixed metal oxides, according to the present invention, microwave energy is used as a heat source, the tubular reactors having no connection portion is used, the temperature at a region which is not irradiated with microwave energy is measured and controlled, and the control of pressure is performed using gas from which solid and the liquid have been separated. By doing so, it is possible to continuously prepare the porous materials and the mixed metal oxides even at high temperature in a stable manner. Furthermore, a reduction in preparation time, an increase in productivity, a reduction in energy, a reduction in reactor volume, and the like, can be achieved, and the inventive method can be a synthesis method which is advantageous in terms of environment and economy. The porous materials prepared according to the present invention can be used as catalysts, catalytic supports and adsorbents and for gas storage, ion exchange and nanosized material preparation. Also, BaTiO₃, which is one of perovskite structures, can be used as electronic ceramic materials such as multi-layer ceramic condensers.

What is claimed is:

1. A method for continuously preparing porous materials and mixed metal oxides by heating reactants to 50-250° C. in the presence of a solvent using microwaves as a heat source, the method comprising the steps of:
continuously supplying the reactants into tubular reactors; and
heating the reactants in the tubular reactors by the microwave energy to continuously prepare the porous materials or the mixed metal oxides;
wherein the pressure of the reactors is controlled by measuring the pressure of gas remaining after separating solid and liquid from a reaction product mixture.

2. The method, of claim 1, wherein a region of the tubular reactors, which is irradiated with the microwave energy, is free of connections.

3. The method of claim 1, wherein the length of the continuous tubular reactors, which are irradiated with the microwaves, is 5-100 cm per microwave generator.

4. The method of claim 1, wherein the tubular reactors are connected in series to increase the residence time therein, or connected in parallel to enhance productivity per time.

5. The method of claim 1, wherein the porous materials is any one selected from the group consisting of zeolite, aluminophosphate, silicoaluminophosphate, metal-containing aluminophosphate, mesoporous materials, and organic-inorganic hybrids.

6. The method of claim 1, wherein the mixed metal oxide is BaTiO₃.

7. The method of claim 1, wherein the preparation of the material comprises adding a seed to the reactants or aging the reactants below the reaction temperature.

8. An apparatus for continuously preparing porous materials and mixed metal oxides by heating reactants to 50-250° C. in the presence of a solvent by using microwaves as a heat source, the apparatus comprising:
a pump for continuously supplying reactants into tubular reactors;
tubular reactors having no connection portion at a region which is irradiated with the microwave energy;
a microwave generator for irradiating the microwave energy into the tubular reactors; and
a pressure measuring and controlling unit for measuring the pressure of gas remaining after separating solid and liquid from a product mixture.

9. The apparatus of claim 8, further comprising a pre-heater for preheating the reactants supplied continuously by the pump, prior to the supply of the reactants into the tubular reactors.

10. The apparatus of claim 8, wherein the tubular reactors are at least two reactors connected in series or in parallel.

11. The apparatus of claim 10, wherein the connection portion of the tubular reactors, which is not irradiated with the microwaves, is formed with a portion for mounting a temperature sensor, a pressure sensor and a rupture thereon.
